(19) United States
(12) Patent Application Publication
(10) Pub. No.: US 2014/0035806 A1
(43) Pub. Date: Feb. 6, 2014

(54) Conductive Fingertip Assembly

(71) Applicant: Jesse Oden, Kalispell, MT (US)

(72) Inventor: Jesse Oden, Kalispell, MT (US)

(21) Appl. No.: 13/930,434

(22) Filed: Jun. 28, 2013

Related U.S. Application Data
(60) Provisional application No. 61/678,157, filed on Aug. 1, 2012.

(51) Int. Cl. G06F 3/01

(52) U.S. Cl. CPC G06F 3/014
USPC 345/156

(57) ABSTRACT

The present invention describes a data input assembly for use with touch screen electronic devices. The assembly includes a set of finger-tip attachments shaped to correspond to the thumb, pointer, and middle fingers of a user The assembly has insulating and conducting layers and enables a user to utilize one or more fingers simultaneously to aid in the use of more complex applications such as playing games and zooming in on text and images. The conducting layer is configured to be inserted in slits within the sleeve of the assembly and when the device comes in contact with the touchscreen of an electronic device, the fingertip assembly transfers the charge from the finger to the electronic device. The assembly further functions to reduce smudges and the transfer of germs onto an electronic device.

### CROSS REFERENCE TO RELATED APPLICATION

This application claims the benefit of U.S. Provisional Application No. 61/678,157 filed on Aug. 1, 2012, entitled “Smart Fingers.” The above identified patent application is herein incorporated by reference in its entirety to provide continuity of disclosure.

### BACKGROUND OF THE INVENTION

1. Field of the Invention

The present invention relates to data input assisting devices. More specifically the invention relates to fingertip covers that transfer energy from a fingertip to the electronic device. The invention is sized to individually fit the thumb, middle, and pointer fingers, and thus is convenient for use on applications that require the use of more than just the thumb of a user.

Cellular phones, tablets, computers, automated teller machines (ATM) and global positioning systems (GPS) are all types of electronic devices that use touch screens. These electronics are a part of the everyday lives of the population, however the way that the devices are operated causes the touch screen to not respond under certain conditions.

Resistive and capacitive touchscreens are the two primary forms of screens used in electronics, wherein both have their advantages and disadvantages. Resistive touchscreens operate by having a glass panel that is covered with conductive and resistive metallic layers. The two layers are held apart and when a user presses against the outer layer, the two layers contact each other and the device identifies where the contact took place. The downside of resistive touchscreens is that they must be pressed down to operate and they are vulnerable to being damaged by sharp objects.

Capacitive touchscreens operate by providing an insulating glass coated with a transparent conductor. When the user touches the screen with their finger, a portion of the charge from the conductor is transferred to the user, causing the electrical charge across the capacitive layer to decrease. The electronic device identifies where the decrease in charge takes place and that information is used to correlate the charge differences with the actions of the user. Although this system provides an advantage over the resistive touchscreen in that it does not require the user to press down on the screen, it still has a setback in that it requires an energy transfer with the person. Therefore, if a user is wearing insulating gloves the touchscreen would not respond to the user's commands.

There are several devices that attempt to relay a signal to a capacitive touch screen when a user is wearing gloves. These devices come in the form of gloves that have metallic projections that have conductive portions that extend from a finger on the glove and make contact with the screen. The setback of these devices is that they are often larger devices that use an entire glove. A further drawback is that they typically only have one finger that possesses the capability of relaying information to the screen.

The present invention relates to a data input assisting assembly for use with capacitive touchscreen devices. The assembly resembles a finger cot and includes a plurality of insulating fingertip covers having a removable conductive material insertable therein. The conductive material is in the form of a metallic strip that enables the transfer of capacitive energy between a user and a touchscreen device to relay information about the actions of the user. The fingertip covers are configured to fit on the thumb, pointer, and middle fingers of a user and the conductive inserts are positioned at spots on the fingertip covers that are optimal for the individual fingers. Having the assembly correspond to individual fingers enables the user to easier navigate applications such as games and perform actions involve the use of two fingers, such as that of zooming in on pictures or text. The assembly additionally assists in decreasing the transfer of germs from the bare skin onto the touchscreen and further helps in preventing smudges on the screen caused by the transfer of dirt or oils from the skin.

2. Description of the Prior Art

Devices have been disclosed in the prior art that relate to data input assisting devices. These include devices that have been patented and published in patent application publications. These devices generally relate to gloves that allow for the transfer of capacitive charge between the screen and the user. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,874,021 to Sunder describes a glove system having inner and outer liners. The outer liner has at least one aperture through which a conductive material is able to contact the touchscreen. Although the system of Sunder is similar in nature and relevant to the present invention, it differs in that it comprises an entire glove instead of removable fingertip covering devices.

U.S. Pat. No. 7,884,797 to Ning teaches a connector comprising a conductive cap and a peg adapted for connection to a glove. The cap is made of a conductive material and comprises a convex shape to aid the user in touching the correct place on the touchscreen device. The connector distributes a charge from the user to the touchscreen by connecting a peg that is attached to the interior of a glove, to the cap that resides exterior to the glove. While the connector of Ning is similar in nature and relevant to the present invention, it differs in that it fails to offer individualized attachments for a user's fingers.

U.S. Patent Application Publication No. 2006/0221066 to Cascella describes a stylus adapted for attachment onto a glove to enable the use of a stylus without requiring the user to hold a pen in their hands. The stylus is attached onto the housing of a glove by gluing and serves to aid the user operation of the touchscreen device. Although the stylus of Cascella is similar in nature and relevant to the present invention, it differs in that it fails to provide glove-like individualized fingertip attachments to aid a user when using a touchscreen.

U.S. Patent Application Publication No. 2007/0245454 to Eklund teaches a glove for use in cold environments. The glove has a fingertip with a rounded tip for communicating with the screen of an electronic device. While the glove of Eklund is similar in nature and relevant to the present invention, it fails to offer individualized covers for a user's fingers, and further differs in that it fails to offer a non-pointed contact device that would prevent scratching of a touchscreen.

U.S. Patent Application Publication No. 2009/0066658 to Earl teaches a glove attachment accessory to aid in communication with touchscreen devices. The device is a plate has a main body and at least two bendable prongs extending from the main body. The prongs are inserted though the tips of the glove and provide a connection between the user's fingers and the touchscreen of the electronic device. Although the glove attachment of Earl is similar in nature and relevant to the present invention, it differs in that it provides an entire glove instead of removable fingertip covering devices.

U.S. Patent Application Publication No. 2009/0278818 to DiNozzi describes a thumb worn accessory for use with electronic devices that have touchscreens. The device comprises a sleeve with a projection extending therefrom; wherein the projection transfers conductive energy from the thumb to the electronic device. While the thumb accessory of DiNozzi is similar in nature and relevant to the present invention, it differs in that it is utilized for precision control of the thumb instead of offering differing attachments for different fingers of a user.

U.S. Patent Application Publication No. 2010/0271339 to Helm teaches a device for facilitating communication a user's thumb and electronics that have touchscreens. The device comprises a finger cavity for receiving the finger of a user and further has a fingertip receiving slot and a projection for communication with the touchscreen device. While the thumb device of Helm is similar in nature and relevant to the present invention, it differs in that it fails to provide differing attachments for each of the fingers of a user.

The present invention relates to a new and improved device that facilities communication between a finger and the touchscreen of an electronic system. The device includes an insulating sleeve that covers the upper portion of a finger of a user and further has slits built in the sleeve that are adapted for the insertion of conductors. The conductors are configured for insertion into the slits and provide for communication between the finger of a user and the screen of an electronic device. The conductive material transfers capacitive energy between a user and a touchscreen device to relay information about the actions of the user. The sleeves are sized for individual insertion onto the thumb, pointer, and middle fingers of the user and the individualized finger attachments aid the user in applications that require the use of two fingers, such as with video games and zooming in on pictures and text. The present invention further acts to reduce the likelihood that germs are transferred between a person and their electronic devices and further aids to smudging of the touchscreen from contact with the oils from the skin of a user.

In view of the drawbacks of the prior art devices, it is shown that the prior art has several known setbacks and that the present invention is substantially divergent in design elements from the prior art and consequently it is clear that there is a need in the art for an improvement to existing conductive gloves. In this regard the instant invention substantially fulfills these needs.

### SUMMARY OF THE INVENTION

In view of the foregoing disadvantages inherent in the known types of conductive gloves now present in the prior art, the present invention provides a new finger cot shaped conductive glove tip wherein the same can be utilized for providing convenience for the user when individualized finger communication with a touchscreen device is desired.

It is therefore an object of the present invention to provide a new and improved touchscreen communication glove tip device that has all of the advantages of the prior art and none of the disadvantages.

It is another object of the present invention to provide a finger cot comprising a conductive material.

Another object of the present invention is to provide individual finger cots configured for placement on one of a thumb, pointer, and middle finger.

Yet another object of the present invention is to provide a finger cot tip comprising a removable conductive material.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates a perspective view of the preferred embodiment of the present invention.

FIG. 2 illustrates a perspective view of the conductive material of the preferred embodiment of the present invention.

FIG. 3 illustrates a detailed view of the preferred embodiment of the present invention.

FIG. 4 illustrates a perspective view of the preferred embodiment of the present invention in use.

FIG. 5 illustrates a perspective view of the preferred embodiment of the present invention in use.

### DETAILED DESCRIPTION OF THE INVENTION

Reference is made herein to the attached drawings. Like reference numerals are used throughout the drawings to depict like or similar elements of the conductive glove tip. For the purposes of presenting a brief and clear description of the present invention, the preferred embodiment will be discussed as used for communication with a touchscreen device. The figures are intended for representative purposes only and should not be considered to be limiting in any respect.

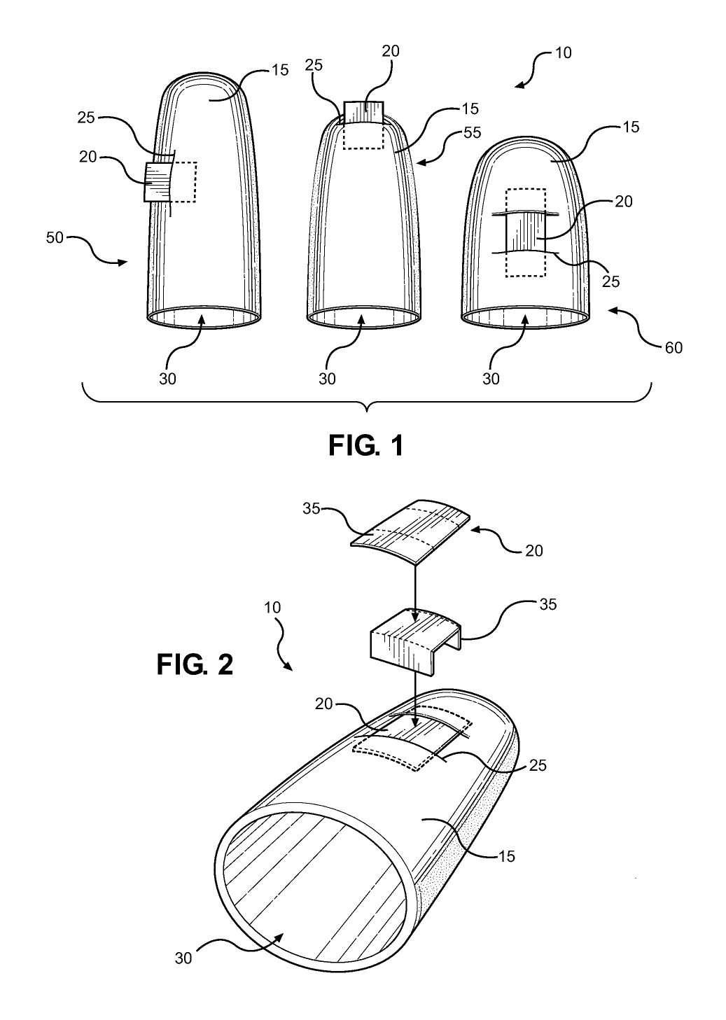

Referring now to FIG. 1, there is shown a perspective view of the conductive fingertip glove assembly of the present invention. The fingertip assembly has finger cot-like coverings 10 having an outer insulating portion 15, an inner conductive portion 20, slits 25 for the joining of the conductive material 20 to the insulating portion 15, and openings 30 for the reception of the finger of a user. The finger cot coverings 10 are sized and shaped to fit over specific finger tips of a user and can come in three or more sizes 50, 55, 60. Individualized finger cots 10 that are adapted to fit a pointer finger, middle finger, and thumb are displayed, however the finger cots can be sized to fit any of the fingers of a user's hand.

Referring to FIG. 2, the outer insulating material 15 is shaped to fit the tip of a user's finger and comprises and opening 30 on the bottom thereof for the reception of the finger of a user. The insulating material 15 can be made of any one of a variety of materials that are suitable for fingertip covering, including that of: leather, synthetic rubbers, plastics and wools. The finger cots 10 function to prevent the transmission of germs and sickness between a person and their electronic devices, while still enabling a person to use their touchscreen. Oils, smears, and smudges from a user prevent the touchscreen from responding properly and the assembly aids in reducing the touchscreen disrupting elements that are transferred between the hands of a user and the touchscreen of an electronic device.

The inner conductive portion 20 can be made of aluminum or any suitable conductive metal known in the art. The inner conductive portion 20 is inserted within slits 25 that are located parallel to each other on the insulating portion 15. The conductive portions 20 are removably insertable within the slits 25 and the location of the slits 25 on the insulated portion 20 differ for each finger type. As shown in FIG. 1, the cots 10 adapted to fit the thumb 60 and pointer fingers 50 have slits on the face of the finger cot 10 and the cot adapted to fit the middle finger 55 has the slits 25 located closer to the tip of the finger cot 10.

Referring again to FIG. 2 there is shown a perspective view of the conductive material 20 of the present invention. The conductive insert 20 is rectangular shape and may be made of a flexible and conductive material such as aluminum. The sides 35 of the conductive insert 20 are bendable to enable insertion within the slits 25 of the insulating portion 15. It is also within the scope of the invention to provide flexible plastics embedded with conductive materials.

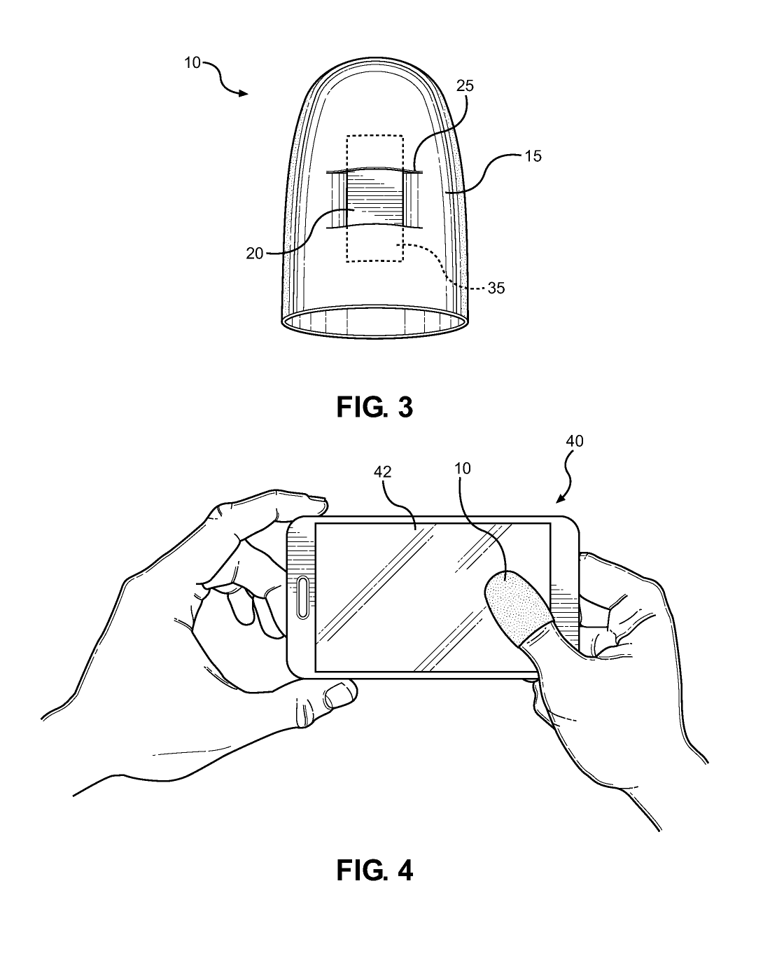

FIG. 3 illustrates a perspective view of the connection between the inner conductive layer 20 and the outer insulating layer 15 of the fingertip assembly of the present invention. The insulating layer 15 is shown to comprise two parallel slits 25 and the conductive material 20 is placed within the slits 25 and remains exposed across the area between the slits. An outline shows the conductive material 20 within the interior of the insulated layer 15, wherein the sides 35 of the material lie against the interior of the insulated layer, where they come into contact with the finger of a user.

When an uncovered portion of a user's body touches a touchscreen device, a change in the electrical charge across the touchscreen occurs and the device is able to identify where the contact occurred and uses that information to perform a desired action. However, when a finger is insulated from contacting the touchscreen, there is a lack of change in the capacitive layer of the touchscreen and no actions are performed by the device. When a user's finger is placed within the insulating layer of the finger cot assembly, the finger comes in contact with the conductive material. The conductive material facilitates communication between the user's finger within the finger cot and the electronic device. When the user touches the screen with their finger, a portion of the charge from the conductor is transferred to the user, causing the electrical charge across the capacitive layer to decrease. That decrease in the capacitive layer of the touchscreen is used to perform any number of movements and commands by the user.

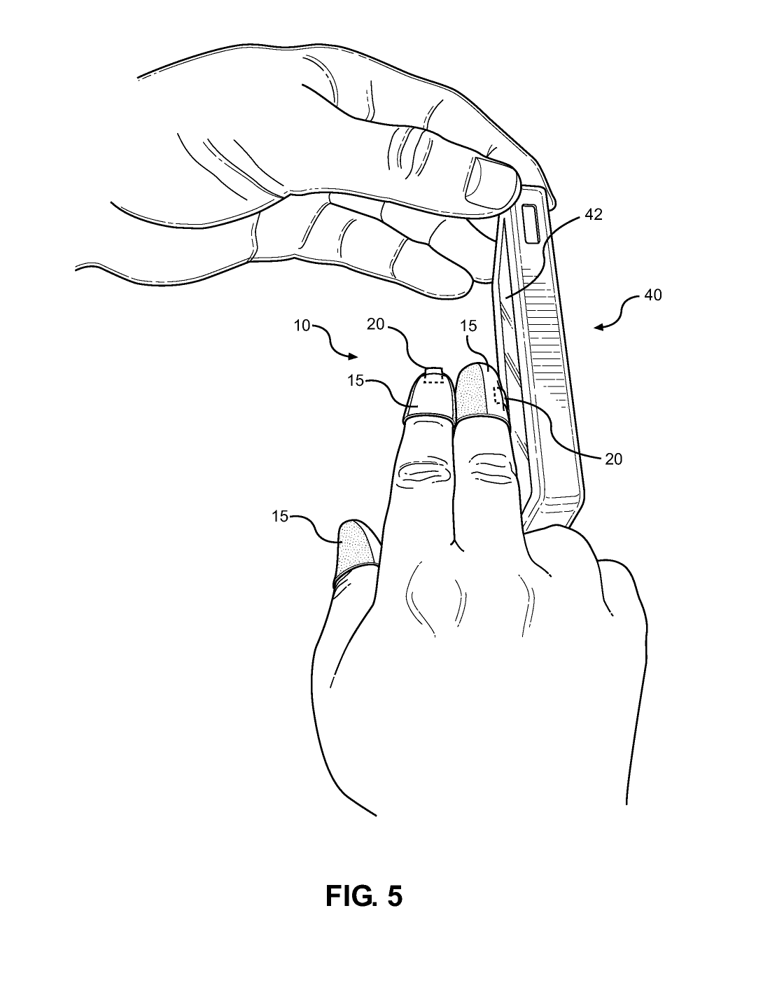

FIGS. 4 and 5 illustrates the preferred embodiment of the present invention while on use on a cellular device 40. The finger cot assembly 10 aids the user when they want to restrict direct contact with their electronic device 40, while also enabling control over the actions of the touchscreen. FIG. 5 illustrates the finger cot assembly 10 positioned on a different rotational orientation on a user's fingers. Certain applications on electronics that use touchscreens are easier used with different portions of the fingers and the ability of the finger cot 10 to rotate around the finger while maintaining connection with the conductive strip 20 adds to its functional value.

As illustrated in FIGS. 1-5, the present invention provides a new and improved finger cot assembly 10 that enables a way for a user to reduce their exposure to a touchscreen 42 of an electronic device 40, while still providing communication between a user and the electronic device 40. The present invention comprises a finger cot assembly 10 that is individually configured for placement on one or more of a thumb, pointer, and middle fingers. The assembly 10 covers the fingertips of a user and functions to reduce the transfer of germs and infection onto the device, and further aids in reducing the transfer of oils that cause smudges that decrease electronic responsiveness from the user to the screen. The finger cot assembly 10 has an outer insulated layer 15 that reduces contact between the user and an electronic device 40, and a conductive insert 20 that relays touchpad contact information to the device. The conductive insert 20 functions by transferring the electrical charges that lie in the user to the touchscreen device 40. This transfer causes a reduction in the electrical charge of a capacitive layer of the touchscreen device 40. The device recognizes and locates this charge difference and a corresponding action is applied that matches the movement of the user. This assembly 10 serves to reduce the transfer of germs and oils from a user to an electronic device, prevent smudging, and provides individualized fingertips for the fingers of a user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fingertip covering assembly comprising:
a finger cot having an outer insulating material sized to receive only the fingertips of a user, wherein said insulating material comprises two parallel slits;
and an inner conductive material, wherein the ends of the said inner material are positioned within said slits, and wherein the central portion of said slits is exposed outside of said slits.

2) The fingertip assembly of claim 1, wherein said ends of said inner conductive material contacts a finger of a user and said central portion of said conductive material lies on a surface of said insulating material.

3) The fingertip covering assembly of claim 1, wherein said finger cots are sized and shaped to correspond with individual fingers of a user when in use.

4) The fingertip covering assembly of claim 1, wherein said slits of said outer insulating layer are placed in different places to suit the needs of individual fingers when in use.

5) The fingertip covering assembly of claim 1, wherein said conductive material is removable from the said slits of said insulating material.
